(19) United States
(12) Patent Application Publication
(10) Pub. No.: US 2003/0078849 A1
(43) Pub. Date: Apr. 24, 2003

(54) Self-checkout system having component video camera for produce purchase monitoring

(75) Inventor: Robert L. Snyder, Suwanee, GA (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation

(21) Appl. No.: 10/033,121

(22) Filed: Oct. 23, 2001

(51) Int. Cl. G06F 17/60

(52) U.S. Cl. 705/23

(57) ABSTRACT

A monitoring system for a self-service checkout system includes a component video camera, such as an RGB component video camera or an analog component video camera. The component video camera is coupled to the processor of a self-service checkout terminal and is operative to obtain a digital picture of an item during the self-checkout transaction. Preferably, the component video camera is operative to obtain a digital picture of an item such as produce when the item is on a scale of the self-checkout terminal and being weighed. This provides a high probability that the customer is not blocking the component video camera. The self-service checkout terminal is in communication with a monitoring station via a network such that the monitoring station can view the digital picture and/or store the digital picture. The digital picture can then be associated with the purchase transaction in a data warehouse. An attendant at a monitoring station can review the picture of an item being weighed virtually at the moment the item is being weighed.

### BACKGROUND

### FIELD OF THE INVENTION

The present invention relates generally to self-service checkout systems for retail businesses and, more particularly, to a self-service checkout system monitoring system.

### BACKGROUND INFORMATION

In the retail industry in general, the largest expenditures are typically the cost of the goods sold followed closely by the cost of labor expended. As with any industry, reducing expenditures can correlate to an increase in profits by reducing overhead costs. The cost of the goods sold, however, cannot necessarily be reduced. Therefore, labor costs have been the focus of reduced expenditures.

With particular regard to the retail grocery or supermarket industry, the impetus to reduce labor costs has focused on reducing or eliminating the amount of time required to handle and/or process the items or goods to be purchased by a customer. To this end, there have been a number of self-service checkout systems developed that attempt to substantially eliminate the need for a checkout clerk. Eliminating the need for a checkout clerk reduces labor expenditures.

Self-checkout systems are thus deployed in order to eliminate the need for a checkout clerk and to help facilitate a faster checkout experience for the consumer. These self-service checkout systems typically require a consumer to scan individual item or items for purchase and then place the scanned items into a grocery bag. The customer then pays for his or her purchases either at the self-service checkout system, if so equipped, or at a central payment area which is staffed by a store employee. Thus, a self-service checkout system permits a customer to select, itemize, and in some cases pay for his or her purchase(s) without the assistance of the retailer's personnel.

It should be appreciated that a retailer may have a number of reservations in regard to implementation of self-service checkout systems in the retailer's operation. For example, certain self-service checkout systems that have heretofore been designed are more expensive relative to assisted checkout systems (i.e. retail checkout systems that are operated by an employee of the retailer such as a checkout clerk). The higher cost associated with a self-service checkout system is typically due to the fact that the system itself must perform functions that would normally be performed by the checkout clerk operating the checkout system, thereby increasing the number of components associated with the self-service checkout system. For instance, in the case of a self-service, and as another example of a reservation held by the retailer, the self-service checkout system must provide security from improprieties such as theft. Moreover, in certain self-service checkout systems, the checkout system itself must collect payment from the customer for his or her items for purchase.

Various security systems have been developed to provide various levels of security to deter and/or alleviate improprieties during the self-service checkout procedure. One such system is the use of a security scale. Once an item for purchase has been scanned, the item is then placed on the security scale. The security scale is used to identify and isolate the item in order to perform a security check. The self-service checkout system checks the weight of the item on the scale to the just scanned item in order to make sure they correlate. If the item weight correlates to the scanned item, the item is placed into a grocery bag. If, however, the item weight does not correlate to the scanned item, the self-service system provides a security alert.

In addition to security scales, a self-service checkout system may utilize a closed circuit camera. The closed circuit camera is used to verify the identity of the item or items scanned then weighed on the security scale or the identity of those items that are only weighed, such as produce. Such verification may be manual (visual identification) or automatic (computer controlled). The closed circuit camera is part of an external, closed circuit video system that is almost completely separate from the self-service checkout computer system and must be controlled via a separate interface such as an RS232 interface. Such current closed circuit camera solutions thus require expensive composite video signal format cameras, typically NTSC (National Television Standards Committee) for operation. Since equipment cost is a factor in reducing overhead costs, current implementation of video monitoring in self-service checkout systems is cost prohibitive.

Additionally, with closed circuit video monitoring, a self-service transaction is monitored in real time. This requires the full attention of a monitoring employee as well as relying on the memory of the monitoring employee for recall. While closed circuit video monitoring can be taped, taping is cumbersome to accomplish and play back, as well as taking up a maximum amount of space for both the recorder and the tapes.

What is therefore needed is a self-service checkout system that overcomes one or more of the above-mentioned drawbacks. What is particularly needed is a self-service checkout system that implements low-cost video monitoring.

What is further needed is a self-service checkout system that utilizes a component video camera for video monitoring.

What is still further needed is a self-service checkout system that utilizes a component video camera for video monitoring of items being weighed for purchase.

### SUMMARY OF THE INVENTION

The subject invention is a self-service checkout system utilizing a component video monitoring system. The self-service checkout system utilizes a component video camera to obtain pictures of items for purchase. Particularly, the self-service checkout system utilizes the component video camera to obtain digital pictures of produce being weighed for purchase during the weighing process.

A monitoring station receives the digital picture of the produce at the time of being weighed at the time of weighing to provide data for approving or disapproving the transaction. The digital picture of tile produce at the time of being weighed may be stored for later retrieval. As well the digital picture of the produce at the time of being weighed may be correlated with the checkout transaction through association of the digital picture with a digital receipt. Additionally, an attendant at a monitoring station may review the digital picture of the produce or item virtually at the moment that the produce or item is being weighed in order to approve or disapprove of the transaction.

In accordance with an aspect of the subject invention, there is provided a method of operating a self-service checkout terminal. The method includes the steps of (a) initiating a checkout transaction at the self-service checkout terminal, (b) obtaining weight of a produce item via a scale of t:he self-service checkout terminal, and (c) acquiring a digital picture of the produce item via a component video camera of the self-service checkout terminal when the weight of the produce item is obtained.

In accordance with another aspect of the subject invention, there is provided a self-service checkout terminal. The self-service checkout terminal includes a processing unit, a component video camera in communication with the processing unit, a produce scale in communication with the processing unit, and memory in communication with the processing unit. The memory contains program instructions which, when executed by the processing unit, causes the processing unit to (i) initiate a checkout transaction at the self-service checkout terminal, (ii) obtain weight of a produce item via a produce scale of the self-service checkout terminal, and (iii) acquire a digital picture of the produce item when the weight of the produce item is obtained.

In accordance with yet another aspect of the subject invention, there is provided a self-service checkout system including a self-service checkout terminal, a monitoring station, and a network providing communication between the self-service checkout terminal and the monitoring station. The self-service checkout terminal includes a first processing unit, a component video camera in communication with the processing unit, a produce scale in communication with the processing unit, and first memory in communication with the processing unit. The first memory contains program instructions which, when executed by the processing unit, causes the processing unit to (i) initiate a checkout transaction at the self-service checkout terminal, (ii) obtain weight of a produce item via a produce scale of the self-service checkout terminal, (iii) acquire a digital picture of the produce item when the weight of the produce item is obtained, and (iv) transmit the acquired digital picture of the produce item to said monitoring station via said network. The monitoring station includes a second processing unit, a display in communication with the processing unit, and second memory in communication with the processing unit. The second memory contains program instructions which, when executed by the processing unit, causes the processing unit to (i) receive the digital picture of the produce item from the self-service checkout terminal via the network; and (ii) display the digital picture of the produce item on the display.

It is therefore an object of the subject invention to provide a new and useful self-service checkout system.

It is moreover an object of the subject invention to provide an improved self-service checkout system.

It is a further object of the subject invention to provide a new and useful method of operating a self-service checkout system.

It is moreover an object of the subject invention to provide an improved method of operating a self-service checkout system.

It is yet another object of the subject invention to provide a low-cost, easy to implement monitoring system and method thereof in a self-service checkout system.

It is moreover an object of the subject invention to provide a low-cost, easy to implement video monitoring system and method thereof for produce purchasing in a self-service checkout system.

The above and other objects, features, and advantages of the subject invention will become apparent from the following description and the attached drawings.

### BRIEF DESCRIPTION OF THE DRAWINGS

FIG. 1 is a block representation of a self-service checkout system in accordance with the principles of the subject invention;

FIG. 2 is an exemplary embodiment of a self-service checkout terminal incorporating the subject invention in accordance with the present principles;

FIG. 3 is a block diagram of the self-service checkout terminal of FIG. 2;

FIG. 4 is a block diagram representation of various exemplary software applications stored in memory;

FIG. 5 is a block diagram of an exemplary monitoring station; and

FIG. 6 is a flowchart of an exemplary manner of operation of the subject invention.

Corresponding reference characters indicate corresponding parts throughout the several views.

### DETAILED DESCRIPTION OF THE INVENTION

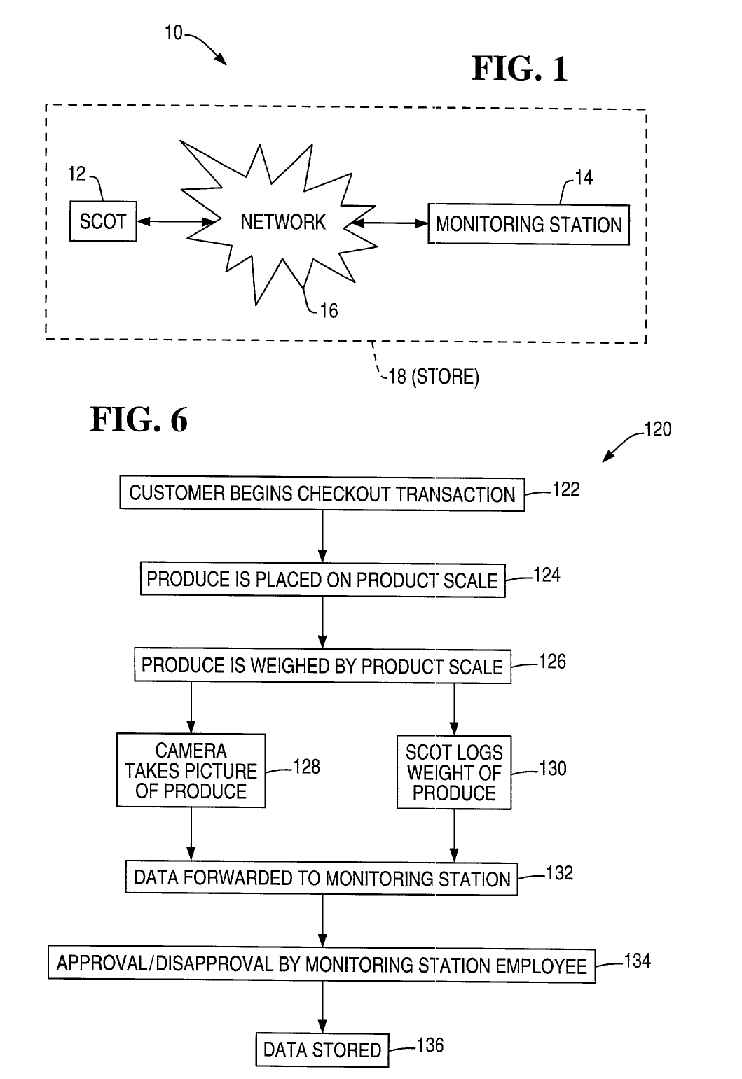

Referring to FIG. 1, there is depicted a self-service checkout or self-checkout system generally designated 10 in which the subject invention is utilized. The self-service checkout system 10 includes a self-service checkout terminal or self-checkout terminal (SCOT) 12. The SCOT 12 is in communication with a monitoring station or area 14 via a network 16. Typically the self-service checkout system 10 is within a retail store 18 and thus is shown in FIG. 1 as such. The network 16 allowing communication between the SCOT 12 and the monitoring station 14 may be any type of public or private electronic network such as a Local Area Network (LAN), the Internet, or the like that can electronically couple or allow electronic communication between one electronic device and another. The network 16 may be wired, wireless, or a combination of wired and wireless. Further, it should be appreciated that while the monitoring station 14 is depicted in FIG. 1 as within the same store as the SCOT 12, the monitoring station 14 may be in a different location than the SCOT 12. In this case the network 16 would span the different locations.

In accordance with an aspect of the subject invention, the SCOT 12 is operative to monitor purchase transactions being performed or conducted at the SCOT 12 by the consumer. Particularly, the SCOT 12 is operative to utilize video monitoring of the purchase transaction such that the monitoring station 14 can view the purchase transaction. More particularly, the SCOT 12 is operative to utilize video monitoring to obtain digital pictures and/or real-time video of a purchase transaction and transmit the digital pictures and/or real-time video of the purchase transaction to the monitoring station 14. Still more particularly, the SCOT 12 is operative via a component video camera to obtain a digital picture of a purchase transaction involving produce and transmifting the digital picture to the monitoring station 14. Yet even more particularly, the SCOT 12 is operative to obtain a digital picture of produce at the time of the produce being weighed during a purchase transaction and transmitting the digital picture to the monitoring station 14. A store employee stationed at the monitoring station 14 can view the digital picture(s) and/or real-time video of the purchase transaction. The purchase transaction or a particular item (i.e. produce) being purchased may be approved or disapproved by the store employee based on the video monitoring. Additionally, the digital picture(s) and/or real-time video may be stored for a period of time for analysis or archival purposes such as in a data warehouse. The digital pictures and/or real-time video may also be correlated to the purchase transaction through a digital receipt.

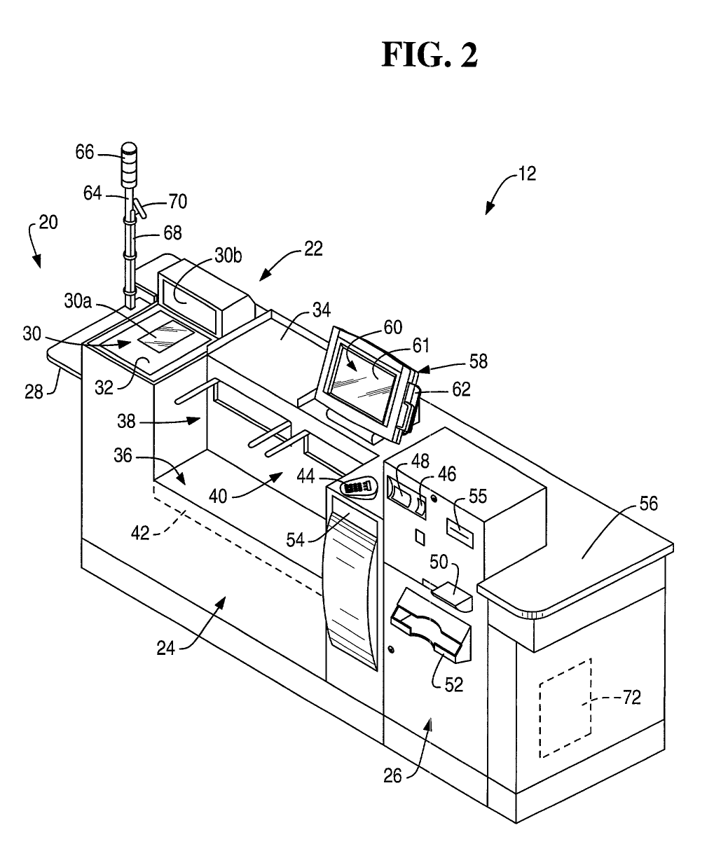

Referring now to FIG. 2, there is shown an embodiment of the retail checkout terminal or system (SCOT) 12 for use in the exemplary retail business or store 18 such as a grocery store. The SCOT 12 is configured to perform a number of retail functions such as unassisted or “self-service” checkout functions. What is meant herein by the term “self-service checkout functions” or “self-service checkout transaction” or “self-service purchase transaction” are those checkout functions or transactions that are performed by a checkout system by the customer himself or herself without the assistance of a clerk or other personnel employed by the retailer. For example, a self-service checkout (purchase) function or transaction would be performed on the SCOT 12 in response to a customer himself or herself scanning or otherwise entering items for purchase into the checkout system, and thereafter depressing a payment key on the checkout system that indicates the manner by which the customer intends to pay for such items (e.g. by interaction with a creditldebit card reader or currency acceptor). Accordingly, what is meant herein by the phrase “self-service mode of operation” is a configuration of the SCOT 12 that allows the system 12 to perform a self-service checkout (purchase) function or transaction.

In addition, what is meant herein by the term “customer” or “consumer” (in the context of the subject invention) is a person who enters a retailer's store, selects his or her items for purchase from the shopping area of the store, checks out his or her items for purchase at a checkout system such as the SCOT 12 (including tendering payment for his or her items for purchase), and then exits the store subsequent to tendering payment. Hence, as used herein, a customer or consumer is distinguished from retail personnel such as a checkout clerk or other employee of the retailer in that a customer or consumer enters the retailer's store 18 for the purpose of purchase items from the store. Moreover, what is meant herein by the term “retail personnel” is a person that is employed by the retailer to perform a retail activity such as operation of the monitoring station 14 or assistance in operation or other function of the SCOT 12. Also, the term “user” is herein used to refer to any operator of the SCOT 12. Accordingly, a user may be a retail personnel, a customer or consumer, or any other person who operates the SCOT 12.

The SCOT 12 includes a pre-scan area 20, an itemization area 22, a bagging area 24, and a payment area 26. The pre-scan area 20 includes a shelf 28 on which a customer may place a shopping basket (not shown) or items for eventual scanning. The pre-scan area 20 provides a place where the customer can place items for purchase before scanning.

The itemization area 22 of the SCOT 12 includes a scanner 30 and a product scale 32. The scanner 30 conventionally scans or reads a product identification code such as a Universal Product Code (UPC), industrial symbol(s), alphanumeric character(s), or other indicia associated with an item to be purchased. One scanner that may be used in the subject invention is a model number 7875 bi-optic scanner that is commercially available from NCR Corporation of Dayton, Ohio.

The scanner 30 includes a first scanning window 30a and a second scanning window 30b. The first scanning window 30a is disposed in a substantially horizontal manner, whereas the second scanning window 30b is disposed in a substantially vertical manner. The horizontal or first scanning window 30a is disposed in a relatively flush-mount arrangement with the product scale 32 such that the product scale 32 is integrated with the scanner 30. If an item such as produce is placed upon the product scale 32 or the first scanning window 30a, the product scale 32 may be used to determine the weight of the produce (item).

The scanner 30 includes a light source (not shown) such as a laser, a rotating mirror (not shown) driven by a motor (not shown), and a mirror array (not shown) such as is conventional in the art. In operation, a laser beam from the laser reflects off the rotating mirror and mirror array to produce a pattern of scanning light beams. As the product identification code on an item is passed over in front of the scanner 30, the scanning light beams scatter off the product identification code and are returned to the scanner 30 where they are collected and detected. The reflected light is then analyzed electronically in order to determine whether the reflected light contains a valid code pattern. If a valid code pattern is detected or present, the product identification code may then be utilized to retrieve product information associated with the item (e.g. the price of the item, product description, or the like).

The itemization area 22 also includes a post-scanning area or shelf 34 on which a customer may place items before being bagged as described below in conjunction with the bagging area 24. While not shown, the itemization area 22 may also include a security deactivation device. The security deactivation device may be provided to deactivate or otherwise disable security tags associated with an electronic article surveillance (EAS) system. In particular, certain items sold by the retailer may have an electronic tag secured thereto. Such electronic tags are generally a label or “clip-on” mechanism that has an electronic transponder imbedded therein that triggers an alarm if the item is taken from the retailer's store without the tag being deactivated or otherwise disabled beforehand. The security deactivation device is utilized to deactivate such electronic tags after scanning.

The bagging area 24 includes a bagwell 36 that is of sufficient size to accommodate a first bag holder/bagging area 38 and a second bag holder/bagging area 40. The first and second bag holder/bagging areas 38 and 40 each are adapted to retain a plurality of paper and/or plastic bags (not shown) for holding scanned items to be purchased. The bagwell 36 is configured such that a bag and its contents (items scanned for purchase) rest upon a security scale 42. The security scale 42 is a weight scale that monitors the weight of items placed into a bag located in the bagwell 36. Such monitoring during a checkout transaction is particularly useful to prevent improprieties during the checkout transaction.

Particularly, the security scale 42 is utilized to monitor the ingress and egress of items into and out of the bagging area 24. More particularly, the security scale 42 is utilized to detect placement of items into and out of the bagwell 36. Such item movement monitoring may be utilized to determine if the customer is unintentionally or intentionally committing an impropriety such as theft. For example, a control signal is generated when the scanner 30 successfully captures a product code associated with an item being entered into the SCOT 12. The security scale 42 may be used to detect placement of an item into the bagging area 24 before being scanned by the scanner 30 in the itemization area 22. Moreover, when an item is scanned with the scanner 30 and thereafter placed into a bag in the bagwell 36, the detected weight of the item (as detected by the security scale 42) may be compared to a known weight value of the item that is stored in a database in order to confirm that a different, more expensive item was not substituted for the scanned item. It should be appreciated that the database may be in the form of a master database that includes every item sold by the retailer, or may be a “transaction level” database that is constructed locally at the SCOT 12 during operation thereof.

The SCOT 12 also includes a user interface terminal for receiving input from and providing information to a customer. In particular, the SCOT 12 includes an interactive customer interface terminal 58. The interactive customer interface terminal 58 includes a display monitor 60 that is provided to display retail information to the customer during operation of the SCOT 12. For example, transaction information such as item price, item description, total amount of the transaction, instructions, etc. is displayed to the customer via the display monitor 60 during operation of the SCOT 12. Moreover, instructions are displayed on the display monitor 60 that assist or otherwise guide the customer through operation of the SCOT 12.

Additionally, customer-specific messages may be displayed to the customer on the display monitor 60 at certain times during a checkout transaction. What is meant herein by the term “customer-specific” in regard to messages is a retail message that is customized for a given customer based on the purchasing habits or other information that is unique to the customer. For example, a customer-specific message may include a customer-specific advertisement that advertises a product that was purchased by the customer during a previous visit to the retailer's store. The SCOT 12 is configured to retrieve information from a customer profile database that contains information about each of the retailer's customers. Moreover, a customer-specific message may include a customer-specific advertisement that advertises a product that may be used in conjunction with a product that was previously scanned or otherwise entered into the SCOT 12 during the current checkout transaction.

The display monitor 60 of the interactive customer interface terminal 58 preferably incorporates a known touch screen monitor 61 that can generate data signals when certain areas of the screen are touched by a customer. Hence, the display monitor 60 may be utilized by the customer to input information into the SCOT 12. For example, the customer may manually enter retail information such as item codes and quantities into the SCOT 12 by use of the touch screen 61 associated with the display monitor 60. The customer may indicate his or her preferred method of payment (e.g. cash, credit card, or debit card) by touching the appropriate area of the touch screen 61 associated with the display monitor 60. A portion of the touch screen 61 associated with the display monitor 60 may also be used as a signature capture area wherein a stylus 62 is used to input a customer's signature in the case of a credit card purchase or other type purchase requiring a signature.

The payment area 26 of the SCOT 12 includes the system components necessary to allow a customer to perform retail finalization functions such as tendering payment for his or her items for purchase and printing of purchase transaction receipts. In particular, the payment area 26 of the SCOT 12 includes an electronic payment terminal 44 having a card reader and keypad, a pair of currency acceptors such as a coin acceptor 46 and a bill acceptor 50, a corresponding pair of currency dispensers such as a coin dispenser 48 and a bill dispenser 52, and a receipt printer 54. As shown in FIG. 1, the system components associated with the payment area 26 are positioned to face the customer.

The system components associated with the payment area 26 of the SCOT 12 are provided to allow the customer to tender payment for his or her items for purchase. In particular, once the customer has entered all of his or her items for purchase into the checkout terminal 10 during a self-service checkout/purchase transaction, the components associated with the payment area 26 are utilized to complete the self-service checkout/purchase transaction by (1) allowing payment to be tendered by either insertion of currency into a currency acceptor (i.e. the coin acceptor 46 and/or the bill acceptor 50), charging a credit card or debit card account, or decreasing a value amount stored on a smart card, cash card, or gift certificate card via the electronic payment terminal 44, and (2) printing a purchase transaction receipt with the receipt printer 54. In the case of when a customer inserts currency into the coin acceptor 46 and/or the bill acceptor 50, the SCOT 12 may provide change via the coin dispenser 48 and/or the bill dispenser 52. The payment area 26 also includes a coupon acceptor 55 that is adapted to receive coupons. The coupon acceptor 55 is operative to read indicia on a coupon to determine if the coupon has expired, the amount, and to correlate whether an item corresponding to the coupon has been scanned for purchase. At the end of the payment anna is a set-aside shelf 56. The set-aside shelf may be used for various purposes such as putting aside bread before placing the same into a bag until the bag is essentially full with heavy items.

The SCOT 12 also includes an accessory pole 65 that supports a status light device 66, an antenna/paging device 68, and a camera 70. The status light device 66 and the antenna/paging device 68 are provided in order to notify store personnel, such as a customer service manager, if intervention into the current checkout transaction is needed. In particular, if during operation of the SCOT 12, an intervention-needed activity is detected, the status light device 66 and/or the antenna/paging device 68 are operated so as to summon retail personnel, such as the customer service manager. What is meant herein by the term “intervention-needed activity” is (1) activity by the customer or retail personnel in which the SCOT 12 is unintentionally operated improperly, (2) activity by the customer or retail personnel in which it can be inferred with a high degree of confidence that the SCOT 12 is intentionally operated improperly for illicit purposes such as theft, (3) activity by the customer or retail personnel in which the customer or retail personnel operates an input device associated with the SCOT 12 in a manner that indicates the he or she is in need of assistance, and (4) activity by the components associated with the SCOT 12 that has rendered the system in need of maintenance or other type of service.

An intervention-needed activity may take the form of a security-breach activity in which the SCOT 12 is being operated in a manner that is placing the retailer in a position of potential financial loss due to goods being taken from the store without having first been paid for (either intentionally or unintentionally), less than all the goods being weighed in the case of produce that results in a false total price for the produce, or a non-security-breach activity in which the customer is in need of assistance or the SCOT 12 is in need of maintenance, but wherein the retailer is not at risk of financial loss due to goods being taken from the store without having been paid for first.

The SCOT 12 also has a video monitoring system that includes a video camera 70. The video camera 70 is included to provide security during operation of the SCOT 12. In particular, the video camera 70 is mounted on the security pole 64 so as to be aimed at the product scale 32. The digital video camera 70 is particularly a component digital video camera such as an RGB component video camera. In an embodiment of the subject invention, the component digital video camera 70 is a web camera.

The camera 70 is mounted on the security pole 64 so as to be aimed at the product or produce scale 32 and is operative to obtain a digital picture of produce being weighed on the product scale 32. More particularly, the camera 70 is operative to obtain a digital picture or pictures of produce on the scale 32 at the time the scale 32 is obtaining the weight of the produce (e.g. the produce is being weighed). This is typically during the checkout or purchase transaction. The obtained digital picture(s) are forwarded or transmitted to the monitoring station 14. This allows an employee at the monitoring station 14 to view what is being weighed at the time of weighing. The employee at the monitoring station 14 may then approve or disapprove the transaction accordingly. In order to obtain an accurate weight of the produce, the customer should not be close to the scale 32 so as to interfere with the camera 70. Thus, at the time of weighing of the produce, the camera 70 is more likely than not to obtain a clear (unobstructed) view of the produce on the scale.

Since the camera 70 is a digital component video camera, the camera 70 is in direct communication with a processing unit or processor 72 of the SCOT 12. The processing unit 70, under direction of program instructions causes the digital picture(s) to be forwarded to the monitoring station 14.

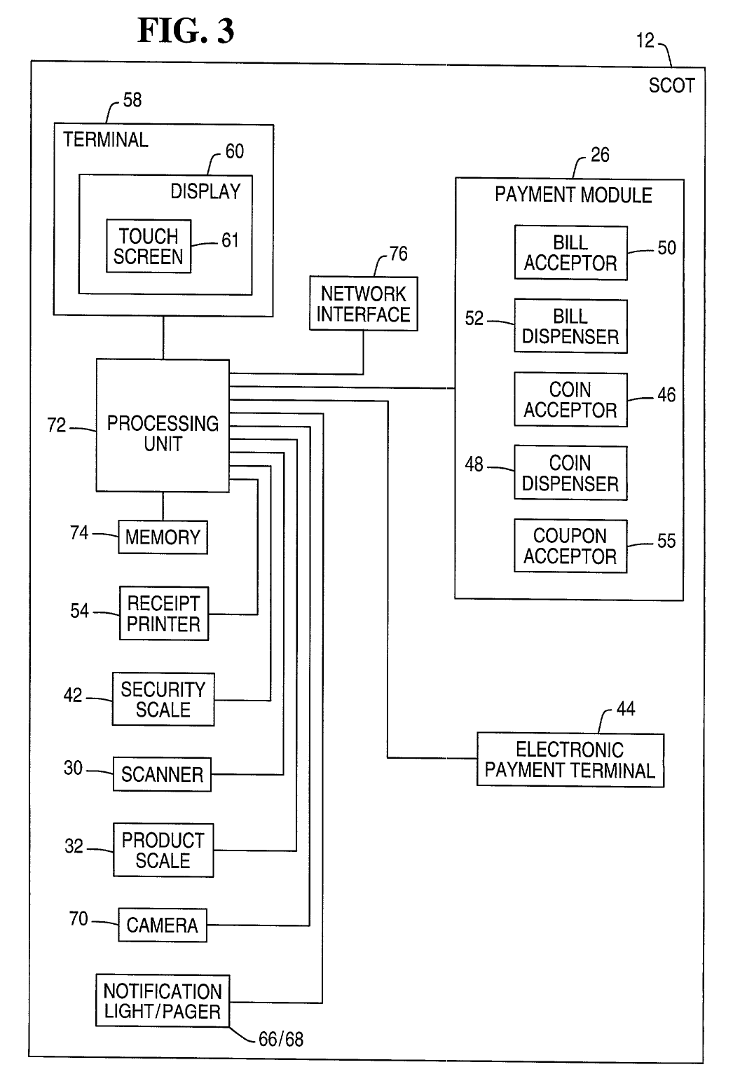

Referring to FIG. 3, the SCOT 12 is shown in block diagram form. The processing unit or processor 72 of the SCOT 12 is in communication with the payment module 26. The payment module 26 encompasses the bill acceptor 50, the bill dispenser 52, the coin acceptor 46, the coin dispenser 48, and the coupon acceptor 55. The processing unit 72 receives input from and essentially controls the payment module 26 (the various components thereof) via software (program instructions) stored in memory 74. Additionally, the processing unit is in communication with the receipt printer 54, the securily scale 42, the scanner 30, the product scale 32, the camera 70, the notification light/pager 66/68, and the terminal 58 including the display 60 and touch screen 61. The SCOT 12 also includes a network interface 76 that is in communication with the processing unit 72 and the network 16.

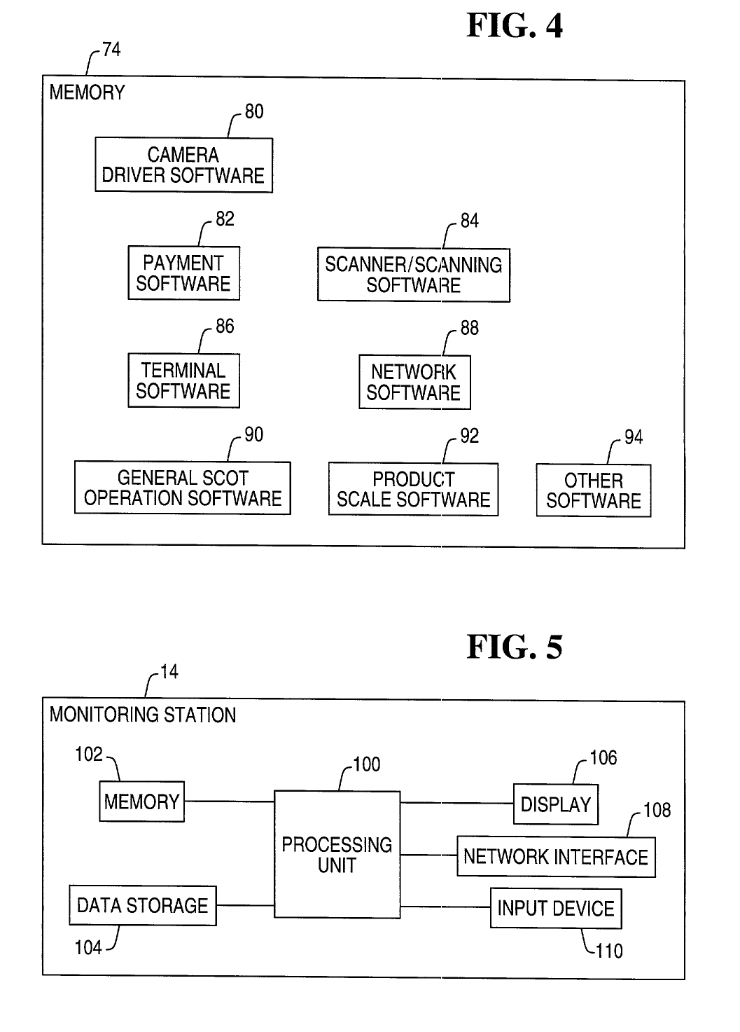

Referring additionally to FIG. 4, the memory 74 contains a plurality of software applications (program instructions) for particular aspects of the SCOT 12. In particular, the memory 74 contains camera driver software 80, payment software 82, scanner/scanning software 84, terminal software 86, network software 88, general SCOT operation software 90, product scale software 92, and other software 94 (encompassing all other software necessary to operate the SCOT 12 and/or perform all necessary functions thereof not specifically mentioned).

The camera driver software 80 is operative to allow the camera 70 to acquire or obtain a digital picture, digital pictures, or digital real-time video (collectively a digital picture), of an item, particularly such as produce, that is being weighed on the product scale 32. The camera drive software 80 preferably obtains the digital picture of the produce (item) at the moment the scale 32 is obtaining the weight of the produce. The camera 70 and the camera driver software 80 preferably are operative to obtain a high-resolution digital picture of the produce. The camera driver software 80 interacts with the other software and various components of the SCOT 12 to forward the acquired digital picture to the monitoring station. In one form, the camera driver software 80 may be video software for Windows® or another suitable program that allows a digital picture from the component video camera 70 to be acquired.

The payment software 82 is operative to allow control of the operation and/or functionality of the various components of the payment module 26 and control of the operation and/or functionality of the electronic payment terminal 44. In the case of payment for the purchase in cash or currency, the payment software 82 is operative to allow the collection of currency via either or both the bill acceptor 50 and/or the coin acceptor 46. In the case of payment by credit card, debit card, smart card, store card, or the like, the payment software 82 is operative to allow the collection of data from the card via the electronic payment terminal 44, obtain any necessary authorization, and conclude the transaction.

The payment software 82 is also operative to control the coupon acceptor 55 and calculate the total amount due for the particular purchase transaction with or without coupons. The receipt printer 54 is under control of the payment software to provide a paper receipt of the purchase transaction. Alternately or in addition to the paper receipt, the SCOT 12 may compile a digital receipt.

The scanner/scanning software 84 is operative to control the operation and/or functionality of the scanner 30. This includes operation of the mechanics of the scanner 30 as well as the reading of the product codes/data from an item or product, and any necessary correlations (i.e. database lookups and the like) of data regarding the product to process the purchase transaction.

The terminal software 86 is operative to drive or operate the terminal 58 including the display 60 and touch screen 61 as appropriate, as well as obtain information input to the SCOT 12 via the terminal 58 (i.e. the display 60 or touch screen 61). When the terminal 58 is in a signature capture mode, the terminal software 86 is operative to obtain the signature input on the touch screen 61, digitize the obtained signature, and process the obtain digital signature as appropriate.

The network software 88 is operative to drive the network interface 76. In particular, the network software 88 is operative to provide the necessary communication protocol(s) to allow communication between the SCOT 12 and the monitoring station 14 over the network 16. Communication between the SCOT 12 and the monitoring station 14 is provided on one hand for the purpose of transmitting the digital pictures acquired by the digital camera 70 during monitoring of the purchase transaction (i.e. monitoring of the scale 32 while produce is being weighed), and on the other hand to provide a disapproval signal to the SCOT 12 from the monitoring station 14 should this be necessary. The disapproval signal causes the SCOT 12 to not accept the data of the particular scan (item transaction) and thus require the customer to redo the particular item transaction or cause a notification signal to be generated. The network software 88 also provides other typical communications functionality.

The product scale software 92 is operative to drive or operate the product or produce scale 32. In particular, the product scale software 92 is operative to obtain a weight of an item such as produce when placed thereon. This is typically accomplished when the SCOT 12 is in a purchase transaction mode. The product scale software also provides a trigger signal for the camera driver software 80 for the camera 70 to obtain a digital picture at the time of stable weight of the produce on the scale 32. That is, when the produce on the scale 32 is stable, the weight as measured by the scale 32 will not fluctuate (or fluctuate within a small amount), thus providing a stable weight measurement. At this time, the customer will not typically be in line with the camera 70. Therefore, the camera 70 can obtain an unobstructed digital picture of the produce at the time of stable weight.

The general SCOT operation software 90 and the other software 94 are operative to provide all other operations and/or functionality of the SCOT 12 not specifically mentioned with respect to the other software, but necessary and/or appropriate for operation of the SCOT 12.

Referring to FIG. 5, there is depicted a block diagram representation of the monitoring station 14. The monitoring station 14 includes a processing unit, processor, or the like 100, memory 102, a data storage device 104, a display 106, a network interface 108, and an input device 110. The monitoring station 14 may also include other components not specifically depicted or mentioned but which are typical of SCOTs.

The processing unit 100 is operative to provide control of the various components of the monitoring station 14 under control of software or program instructions stored in the memory 102. The particular software or program instructions stored in the memory may be similar or in addition to the software described in connection with FIG. 3 or work in conjunction with the software described in connection with FIG. 3. The software stored in the memory 102 may also be particular to the monitoring station 14. The processing unit 100 is operative to process the digital pictures acquired by the camera 70 and forwarded to the monitoring station 14 by the SCOT 12 via the network 16. This includes providing the digital picture to the display 106.

The data storage device 104 is operative to store the digital picture acquired by the camera 70 and associating the digital picture with the particular purchase or checkout transaction. The input device 110 is operative to accept input from the employee or person at the monitoring station 14, while the network interface 108 is operative to allow network communication between the monitoring station 14 and the SCOT 12.

Operation

Referring to FIG. 6, there is depicted a flow chart, generally designated 120, of an exemplary manner of operation of an aspect of the subject invention. In particular, there is depicted the flow chart 120 of an exemplary manner of the monitoring operation of the product scale 32 in conjunction with the component (web) digital camera 70. It should be appreciated that the manner of operation described below in conjunction with the flow chart 120 is only an example of one manner or mode in which the SCOT 12 may implement the subject invention.

In step 122, a customer begins the checkout transaction. This may be initiated by the scanning of an item by the scanner 30, by manually putting the SCOT 12 into a purchase transaction mode via the terminal 58 (touch screen 61 or the like), the reading of a credit, debit, or other card by the electronic payment terminal 44, or the like. In step 124, produce is placed on the scale 32 for weighing. When the produce becomes stable on the scale 32, the scale 32 obtains the weight of the produce, step 126.

When the produce is stable and the weight of the produce is obtained by the scale 32, the camera 70 obtains a digital picture of the produce, step 128. Preferably at the same time, or nearly so, the SCOT 12 logs the weight of the produce, step 130. The weight of the produce is used to calculate the total cost of the produce. In step 132, the weight data and the digital picture data (collectively, product data) is then transmitted to the monitoring station 14. The monitoring station 14 receives the product data and provide the product data to a monitoring station employee for approval or disapproval of the transaction, step 134. It should be appreciated that this step may be automated. If the transaction is not approved, the produce must be removed from the scale 32 and placed back thereon (step 124). Thereafter, the procedure is repeated from step 126. If the transaction is approved, the checkout transaction may proceed. In step 136, the product data is stored.

While this invention has been described as having a preferred design, the subject invention can be further modified within the spirit and scope of this disclosure. This application is therefore intended to cover any variations, uses, or adaptations of the subject invention using its general principles. Further, this application is intended to cover such departures from the present disclosure as come within known or customary practice in the art to which this invention pertains and that fall within the limits of the appended claims.

What is claimed is:

1. A method of operating a self-service checkout terminal comprising the steps of:
initiating a checkout transaction at the self-service checkout terminal;
obtaining weight of a produce item via a scale of the self-service checkout terminal; and
acquiring a digital picture of the produce item via a component video camera of the self-service checkout terminal when the weight of the produce item is obtained.

2. The method of claim 1, further comprising the steps of:
forwarding the acquired digital picture of the produce item to a monitoring station; and
displaying the acquired digital picture of the produce item at the monitoring station.

3. The method of claim 2, further comprising the step of:
permitting one of approval and disapproval of the checkout transaction by the monitoring station based on the obtained weight and the acquired digital picture of the produce item.

4. The method of claim 2, further comprising the steps of:
storing the acquired digital picture of the produce item; and
associating the stored digital picture of the produce item with the checkout transaction.

5. The method of claim 1, wherein the step of acquiring a digital picture of the produce item via a component video camera includes acquiring a digital picture of the produce item via a component video camera comprising a web camera.

6. The method of claim 1, wherein the step of acquiring a digital picture of the produce item via a component video camera includes acquiring a high-resolution digital picture of the produce item via a web camera.

7. The method of claim 1, wherein the step of obtaining weight of the produce item via a scale of the self-service checkout terminal includes the step of waiting for a stable weight period of the produce item on the scale.

8. A self-service checkout terminal comprising:
a processing unit;
a component video camera in communication with said processing unit;
a produce scale in communication with said processing unit; and
memory in communication with said processing unit and containing program instructions which, when executed by said processing unit, causes said processing unit to (i) initiate a checkout transaction at the self-service checkout terminal, (ii) obtain weight of a produce item via a produce scale of the self-service checkout terminal, and (iii) acquire a digital picture of the produce item when the weight of the produce item is obtained.

9. The self-service checkout terminal of claim 8, wherein said component video camera comprises a web camera.

10. The self-service checkout terminal of claim 9, wherein said web camera is operative to obtain a high-resolution digital picture of said produce item.

11. The self-service checkout terminal of claim 8, wherein said memory has further program instructions which, when executed by said processing unit causes said processing unit to (iv) forward the acquired digital picture of the produce item to a monitoring station, and (v) display the acquired digital picture of the produce item at the monitoring station.

12. The self-service checkout terminal of claim 11, wherein said memory has further program instructions which, when executed by said processing unit causes said processing unit to (vi) permit one of approval and disapproval of the checkout transaction by the monitoring station based on the obtained weight and the acquired digital picture of the produce item.

13. The self-service checkout terminal of claim 8, wherein said memory has further program instructions which, when executed by said processing unit causes said processing unit to (iv) store the acquired digital picture of the produce item, and (v) associate the stored digital picture of the produce item with the checkout transaction.

14. The self-service checkout terminal of claim 8, wherein obtaining weight of the produce item via said scale of the self-service checkout terminal includes waiting for a stable weight period of the produce itemi on said scale.

15. A self-service checkout system comprising:
a self-service checkout terminal;
a monitoring station; and
a network providing communication between said self-service checkout terminal and said monitoring station;
said self-service checkout terminal comprising:
a first processing unit;
a component video camera in communication with said processing unit;
a produce scale in communication with said processing unit; and
first memory in communication with said processing unit and containing program instructions which, when executed by said processing unit, causes said processing unit to (i) initiate a checkout transaction at the self-service checkout terminal, (ii) obtain weight of a produce item via a produce scale of the self-service checkout terminal, (iii) acquire a digital picture of the produce item when the weight of the produce item is obtained, and (iv) transmit the acquired digital picture of the produce item to said monitoring station via said network;
said monitoring station comprising:
a second processing unit;
a display in communication with said processing unit; and
second memory in communication with said processing unit and containing program instructions which, when executed by said processing unit, causes said processing unit to (i) receive the digital picture of the produce item from the self-service checkout terminal via the network; and (ii) display the digital picture of the produce item on the display.

16. The self-service checkout system of claim 15, wherein said second memory has further program instructions which, when executed by said second processing unit causes said second processing unit to (iii) permit one of approval and disapproval of the checkout transaction by the monitoring station based on the obtained weight and the acquired digital picture of the produce item.

17. The self-service checkout system of claim 15, wherein said second memory has further program instructions which, when executed by said second processing unit causes said second processing unit to (iii) store the acquired digital picture of the produce item, and (iv) associate the stored digital picture of the produce item with the checkout transaction.

18. The self-service checkout system of claim 15, wherein said component video camera comprises a web camera.

19. The self-service checkout system of claim 18, wherein said web camera is operative to obtain a high-resolution digital picture of the produce item.

20. The self-service checkout system of claim 15, wherein obtaining weight of the produce item via said scale of the self-service checkout terminal includes waiting for a stable weight period of the produce item on said scale.
